(19) United States
(12) Patent Application Publication
(10) Pub. No.: US 2020/0008390 A1
(43) Pub. Date: Jan. 9, 2020

(54) A DEVICE AND METHOD FOR COOLING HORSES AFFECTED BY HEAT STRESS

(71) Applicant: Tomas Michael NOORDHUIZEN, Cadier en Keer (NL)

(72) Inventor: Jos NOORDHUIZEN, Parnay (FR)

(21) Appl. No.: 16/495,061

(22) PCT Filed: Mar. 19, 2018
(86) PCT No.: PCT/EP2018/056908

§ 371 Date: Sep. 17, 2019

(30) Foreign Application Priority Data
Mar. 17, 2017 (EP) 17161705.3

(51) Int. Cl. A01K 1/00; A01K 13/00

(52) U.S. Cl. CPC A01K 1/0082; A01K 13/001

(57) ABSTRACT

The invention shows a cooling device for horses with a stand, which comprises a left and a right side part (22), a front door (24) and a rear door (26), with a water sprayer (46), which is arranged centrally between both side parts (20, 22) and both doors (24, 26) at a height of at least 150 cm, and which has a downwards directed water outlet, and with at least one fan (48), which is arranged adjustable in height and angular orientation above the front door (24) on the stand and directs an air flow with a slow speed to the central region of the stand, where in use the back of the horse is located.

### TECHNICAL FIELD

The invention relates to a device and a method for cooling horses, in particular for cooling heat stressed horses. The invention has particular, but not exclusive, application to the cooling of horses. The invention is also suitable for cooling other animals, in particular quadruped mammals, and more in particular quadruped mammals used in competition.

### BACKGROUND ART

A large variety of devices and methods for cooling horses are known. Commonly, water hosing during a certain amount of time is currently applied. Another method concerns throwing of buckets of cold water onto the back of the horse. Yet another method is putting blankets on the horse which have been drenched in ice-cold water beforehand.

From US 2010/0251969 A1 a cooling device for horses is known, which has a mobile insulated container A that contains water, for example cooled water. Water can be taken out of this container and can be directed via nozzles to a horse next to the container.

The German utility model DE 8 803 706 U1 describes a device for cooling extremities of a horse. Thereby, downwards open tubes are used. The horse stands with its legs in these downwards open tubes. Water flows via nozzles out of the side walls of the tubes towards the inside and onto a leg located in the tube.

The German utility model DE 8 900 025 describes a device for cooling and massaging the legs of horses with water. A trough has a water permeable bottom. A collecting chamber is provided under this trough, which contains water. A pump pumps the water from the collecting chamber into the interior of the trough via a pipe and through nozzles. Thereby, the legs are massaged.

The German utility model DE 29 818 305 describes an device for treating horses. In a substantially hermetically sealed cabin an air temperature can be set in the range from 20° C. to 100° C. and an air humidity in the range of 30% to 70%. It is a kind of a sauna. Cooling does not take place.

The German utility model DE 20 2015 100 684 U1 describes a mobile cabin, which can be sealed by means of a door. A device for generating a mist, in particular a saline mist, as well as a dry-air fan, are located in the cabin.

The UK patent application GB 457 533 A describes a device for showering horses. The device comprises a confining stall with a plurality of spray heads for showering the entire body of a horse. The device may also be used for cooling horses, but showering the entire body of the horse is not an effective method for the treatment of heat stress in horses.

The U.S. Pat. No. 4,476,809 describes a cooling system for cattle confinement pens. The cooling system comprises a plurality of sprinkler heads and spacedly mounted fans on the ceiling of an animal confinement building, wherein the fans oscillate in unison. The purpose of the cooling system is to increase feed consumption and dairy milk output during periods of high temperature and high humidity conditions. The cooling system is used for a large number of animals, and not directed to the treatment of heat stress in horses.

Unfortunately, neither of these devices and methods are effective for cooling horses in order to treat heat stress, and sometimes they are even counterproductive.

### DISCLOSURE OF THE INVENTION

The invention relates in particular to cooling devices for riding horses, especially for sport horses, in particular heat stressed horses. It is in particular intended for use in the warmer regions of Earth, for example, in South Europe, but given the current climate changes it is also intended for use in West Europe, North and South America, the Middle East and the Far East. The cooling device is used in particular in competitions in the field of eventing, e.g. endurance and cross-country, and similar horse riding events in which the horse is heavily stressed and which are demanding for the horse, while ambient temperature and air humidity increase. At the end of the competition, such a horse is usually clearly overheated, it often suffers from heat stress and sometimes heat stroke. This stress occurs in particular after physical activity, when the ambient temperature is above 20° C. and the air humidity is relatively high at the same time, for example above 70%. The horse can then no longer give off its body heat to the exterior in a sufficient quantity; it loses body fluids and exhibits failures of its biological systems in the range of the heart, blood circulation, respiration, liver, brain and intestines. There exist various simple clinical tests, such as for example a thermographic test of the body temperature, or of the nasal mucosa temperature, to show that the horse suffers from heat stress. Other parameters that can be tested to show that the horse suffers from heat stress are for example heart rate, respiratory frequency, skin fold elasticity and capillary refill time. Each heat stressed horse loses its performance capability, and this can even become worse at the next occurrence of heat stress. The welfare of the horse is always impaired and health disorders may occur. Therefore, it is an economical, socio-economical and a health objective, to enable a heat stressed horse to release excess body heat without large health risk and as gently and quickly as possible.

This is where the invention comes into play. The objective of the invention is to provide a cooling device for horses, more specifically heat stressed horses, and to improve thereby the known cooling devices, such that the treatment of horses can be done more selectively, appropriately, easier and quicker, and with a significant lower use of persons, e.g. for moving the nozzles over the back of the horse. Further objectives are to reduce health disorder risks, e.g. colic or heart failure, to improve the impaired welfare and to maintain the performance capability as much as possible.

These objectives are achieved by a device with the features of claim 1.

The device has a stand, dimensioned such that a horse can be accommodated inside the stand. Thereby, a maximum of 50 cm, and more particularly a maximum of 30 cm, shall remain free laterally. In the length, the stand is dimensioned such that it is preferably a maximum of 50 cm, and more particularly a maximum of 30 cm, shorter than the body length of a normal horse. This means that the horse is located with its head outside of the stand, and also a part of the neck is located outside of the stand.

The stand is built on a reference plane, for example the ground. The horse enters the stand through a door, in particular the front door. The rear door remains closed, and the horse is then essentially fixated in the stand, and it has little freedom of movement. It can only move itself back and forth a little, and laterally it also has little freedom of movement. It cannot turn itself in the stand.

For the description a right-handed x-y-z coordinate system is used. The x-axis extends parallel to the right side part and in the direction from the front door towards the rear door. The y-axis extends parallel to the front door in the direction towards the left side part. The reference plane, on which the stand rests, lies in the x-y-plane. The z-axis extends upwards from this reference plane, parallel to the side bar, which is above the right lower corner of the stand. The side parts extend parallel to the x-z-plane. The doors extend parallel to the y-z-plane. The water sprayer is located at a height of at least 150 cm above the reference plane, and preferably higher, preferably at least 180 cm, and more preferably at least 200 cm above the reference plane. The maximum height is about 300 cm. Preferably, the water sprayer is located 50 cm to 150 cm above the back of a horse or above the height at the withers of the horse. The water sprayer has a main discharge direction, which extends parallel to the negative z-direction. The water sprayer sprays in an angular range, e.g. conical. Thereby, the angle of the discharged water is smaller than plus/minus 30°, in particular smaller than plus/minus 20°, from the z-direction. The angle is limited such that substantially all water hits the back, and preferably the sides, of the horse, from neck to tail, and only a little and possibly no water passes the horse laterally. As such, water use per horse per cooling cycle may be limited to a maximum of 28 l/min. Used water can be collected in a collecting tub, filtered and put back into a water cooling system for being reused.

Preferably, the side parts extend in the x-direction from 120 cm to 250 cm, preferably from 160 cm to 210 cm. In the y-direction, the doors preferably have a width of 60 cm to 130 cm, preferably 80 cm to 115 cm. Preferably, the doors and/or the side parts have a crossbar, which is located at a height measured in the z-direction of 110 cm to 140 cm above the reference plane. Preferably, this crossbar is located at the shoulder height of the horse.

Furthermore, the invention relates to a method for cooling an overheated horse, in particular a heat stressed horse, using the cooling device according to claim 1. In this method, the horse is first led through the front door into the stand; the front door is then closed again; the rear door remains closed. Then, in a first step, water is directed via the water sprayer onto the back of the horse; this step is carried out for at least a few minutes, but may also be carried for a shorter period of time, for example at least a few seconds, depending on the method of spraying which is used. Subsequently, the then wet hair coat of the horse can be freed from the water, for example by wiping off the water, for example with a rubber scraper, or by rubbing it dry. In a second step, a weak airflow is then directed by the at least one fan onto the back of the horse from behind; this step is carried out for a few minutes. This step is preferably carried out for at least 1 minute, more preferably for at least 2 minutes, even more preferably for at least 3 minutes, and preferably at most 7 minutes, more preferably at most 6 minutes, even more preferably at most 5 minutes. Finally, the rear door is opened; the horse is led out of the stand.

Preferably, the weak airflow is directed at least onto the back of the horse, and may also be directed to a wider range also covering the belly and/or the legs of the horse. Preferably, the weak airflow is directed onto the back of the horse, or a wider range, by two fans operating in a crossway fashion. This increases heat evaporation from the skin of the horse.

The steps of directing water via the water sprayer onto the horse, freeing the water from the wet hair coat of the horse and directing the weak airflow onto the back of the horse, are can be referred to as a cooling cycle. Some horses need only one such cooling cycle, but others might need more cooling cycles, which may for example be determined by the clinical parameters.

Finely dispersed water may be sprayed onto the back of the horse via the water sprayer; the water is preferably finely nebulised and in particular as finely as possible. Water droplets of the finely nebulised water preferably have a diameter of at most 1 mm, and more preferably of at most 0.5 mm. It absorbs the heat and leads it away, such that the horse is cooled quickly and over a large area. This process takes a certain amount of time, and is preferably carried out for at least a few minutes. This step is, in this case, preferably carried out for at least 1 minute, more preferably for at least 2 minutes, even more preferably for at least 3 minutes, and preferably for at most 7 minutes, more preferably for at most 6 minutes, even more preferably for at most 5 minutes. Afterwards, the horse can be dried at least slightly, for example by wiping the water from the hair coat. In the next step, the at least one fan is used. It directs an airflow with very low wind speed onto the back of the horse.

Large water droplets may be sprayed onto the back of the horse, i.e. water droplets imitating natural rainfall. The water droplets have a diameter of at least 0.5 mm, preferably at least 1 mm, more preferably at least 2 mm, and a diameter of at most 8 mm, preferably at most 5 mm, and more preferably at most 4 mm. This allows the water to better reach the skin of the horse underneath the hair coat. It absorbs the heat and leads it away, such that the horse is cooled quickly and over a large area. This process may take a shorter amount of time. This step is, in this case, preferably carried out for at least 10 seconds, more preferably for at least 20 seconds, even more preferably for at least 30 seconds, and preferably for at most 80 seconds, more preferably for at most 70 seconds, even more preferably for at most 60 seconds. Afterwards, the horse can be dried at least slightly, for example by wiping the water from the hair coat. In the next step, the at least one fan is used. It directs an airflow with very low wind speed onto the back of the horse.

Preferably, the parts of the stand are connected to each other in a quickly releasable manner. They may for example be connected by screw or plug-type connections, or by grip/clutch-type connections. In this manner, the four main parts of the stand can be transported easily and can also be built up easily on site, for example at a competition. The four main parts, i.e. both side parts and both doors, are preferably flat parts that can be easily transported, for example in a truck or a shipping container.

The cooling device may comprise a single stand for being used as a stand-alone unit, but the cooling device may also comprise a plurality of the stands, e.g. 12 stands, in a so-called carousel. The latter embodiment of the cooling device is especially meant for large horse stables and for competitions.

Preferably, a collecting tub is provided, which is located in the stand between the side parts and the doors and fills an as large part as possible of the floor area of the stand. It lies on the reference plane. The collecting tub has side walls, which preferably have a height of at most 30 cm, and in particular of at most 20 cm. In the collecting tub there can be provided an outlet and/or a pump device. The collected water can be recycled and reused, preferably after being filtered and cooled first. The collecting tub is laid into the stand or lies on the reference plane before it is assembled. It is preferably not connected to the stand. It is arranged such that the horse is able to enter the bottom of the collecting tub and such that it has a correspondingly solid construction. Preferably, an elastic mattress or mat is provided, which is located on the bottom of the collecting tub. The mattress is preferably a non-slippery mattress, and is therefore preferably provided with large meshes. It is for example manufactured from an elastomeric foam.

Preferably, the side parts and/or the doors are configured to be permeable as much as possible. They are in particular grid shaped. They have a surface area which is more than 50% open, in particular more than 80% open. This means that the surface area of the side parts is constructed of less than 50%, in particular of less than 20%, solid material. This principle enables a large airflow within the stand, which covers the entire body of the horse. The grid shape also prevents the horse from getting trapped in the doors and/or the side parts. The grid shape may for example be provided by a strong gaze wire which is welded on the side parts and/or the doors.

Preferably two fans are provided, both of which are positioned above the front door and offset from each other. They are preferably aligned such that their air flows cross each other. This should be done in particular in the area of the back of the horse, and optionally also in the area of the neck, the belly, the tail and the legs of the horse.

The cooling device according to the present invention may also be used for cooling other animals cooling other animals affected by heat stress, in particular quadruped mammals, and more in particular quadruped mammals used in competitions, such as for example race camels or race dogs. In such cases the dimensions of the cooling device need to be adapted relative to the animal for which the cooling device is supposed to be used. The stand of the cooling device is in this case preferably dimensioned such that the animal can be accommodated inside the stand. Thereby, a maximum of 50 cm, and more particularly a maximum of 30 cm, shall remain free laterally. In the length, the stand is dimensioned such that it is preferably a maximum of 50 cm, and more particularly a maximum of 30 cm, shorter than the body length of the normal or average length of the animal. This means that the animal is located with its head outside of the stand, and also a part of the neck is located outside of the stand, for which the height of the rear door should be adapted. Preferably, the water sprayer is located 50 cm to 150 cm above the back of the animal or above the height at the withers of the animal. For a device for cooling a camel, in particular a heat stressed camel, the following dimensions may for example be used: length in the range of 220 cm to 300 cm, and preferably about 250 cm; height, i.e. height of the water sprayer, in the range of 220 cm to 300 cm, preferably and about 250 cm; and width in the range of 100 cm to 130 cm. Other components of the cooling device may be adapted accordingly to the dimensions of the animal, if necessary.

### BRIEF DESCRIPTION OF THE DRAWINGS

Other advantages and features of the invention become apparent from the other claims, as well as from the following description of two exemplary non-limiting embodiments of the invention, which will be further elucidated below with reference to the drawings.

FIG. 1 shows a perspective view of a first embodiment in the form of a non-demountable stand with a horse therein,

FIG. 2 shows a perspective view of a second, demountable and thus mobile embodiment of the cooling device; viewing direction according to the drawn-in coordinate system.

FIG. 3 shows a perspective view of the device from another viewpoint according to FIG. 2, the viewing direction is again derived from the coordinate system.

### MODES FOR CARRYING OUT THE INVENTION

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice of the invention.

Furthermore, the terms first, second, third and the like in the description and in the claims, are used for distinguishing between similar elements and not necessarily for describing a sequential or chronological order. The terms are interchangeable under appropriate circumstances and the embodiments of the invention can operate in other sequences than described or illustrated herein.

Moreover, the terms top, bottom, over, under and the like in the description and the claims are used for descriptive purposes and not necessarily for describing relative positions. The terms so used are interchangeable under appropriate circumstances and the embodiments of the invention described herein can operate in other orientations than described or illustrated herein.

The term “comprising”, used in the claims, should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

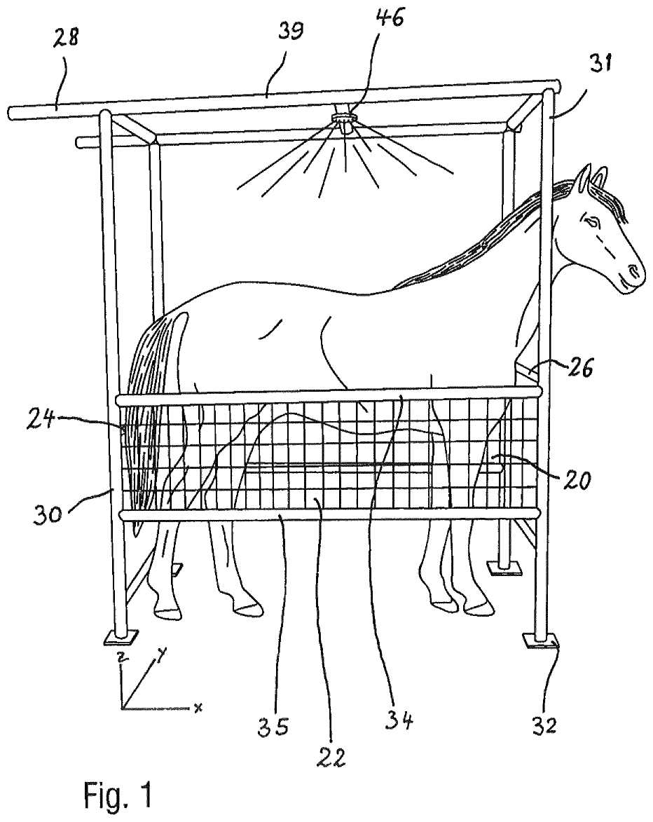

The inventive cooling device for horses, in particular heat stressed horses, has a stand which has four sides. The stand delimits a substantially rectangular space, in which space a horse shall be located, as can be seen in FIG. 1. The stand has a left side part 20 and a right side part 22. Both are preferably identical in construction. These side parts 20, 22 extend parallel to each other. Their distance is 80 cm to 120 cm; preferably, it is in the range of about 1 m.

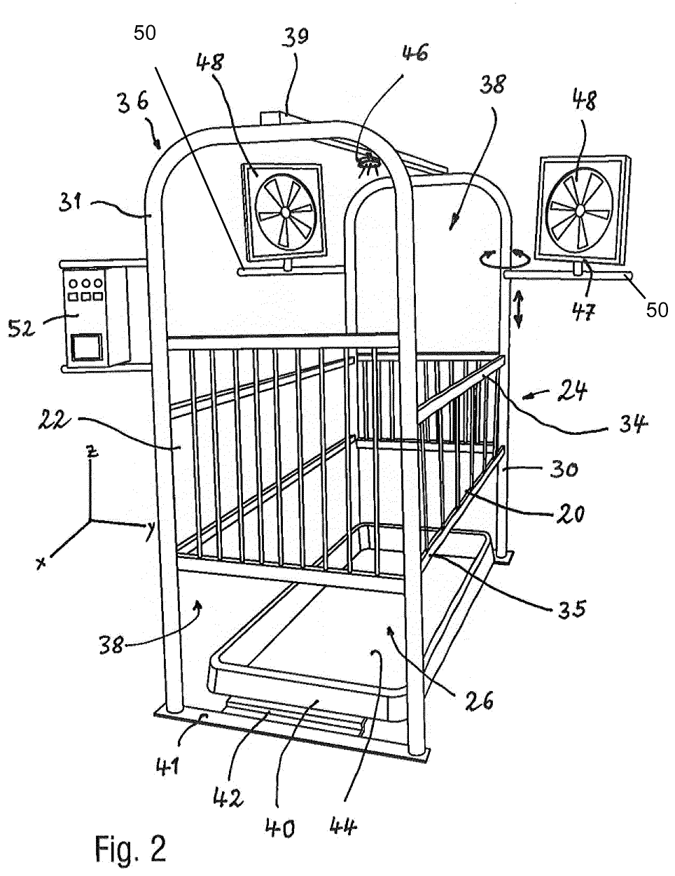

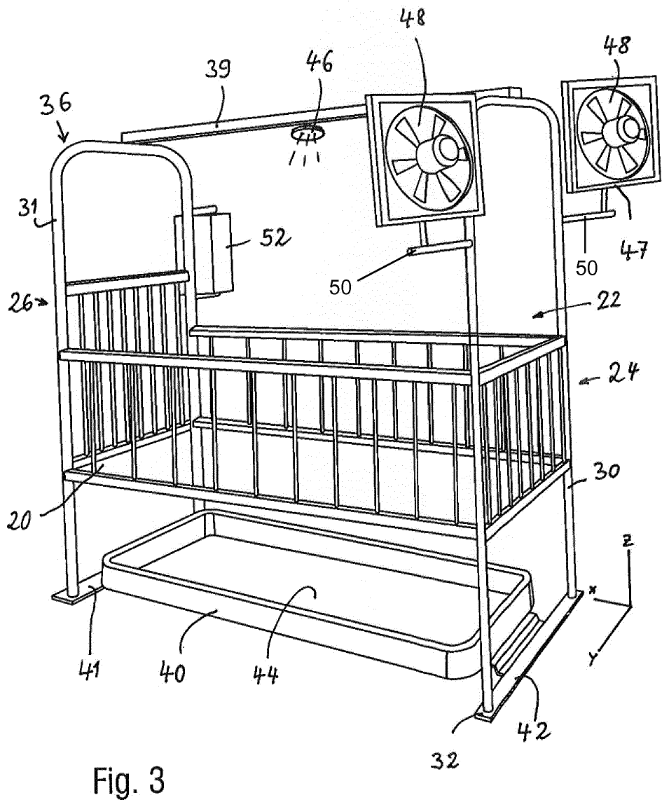

Two doors, in particular a front door 24 and a rear door 26, extend transverse to both side parts 20, 22. Each of these doors 24, 26 is arranged between the side parts 20, 22 and connect them. The doors 24, 26 can be opened to the outside, not to the inside. The doors 24, 26 have hinges; it is advantageous to provide the hinges on different side parts. Alternatively, the hinges may also be arranged on a door frame, which is connected to the side parts 20, 22, as can be seen in FIGS. 2 and 3.

As is apparent from the Figures, the side parts 20, 22 and the doors 24, 26 are in both exemplary embodiments substantially flat parts; their thickness is in the range from 2 cm to 8 cm, preferably about 6 cm.

The side parts 20, 22 preferably have a length of 120 cm to 250 cm, in particular 160 cm to 210 cm, whereby the length is measured in the x-direction. In the z-direction, the height of the side parts 20, 22 is generally not critical; a dimension in the range of 40 cm to 80 cm, for example about 60 cm, is considered to be favourable. Thereby, the side parts 20, 22 preferably have a crossbar 34 on top located at a height of about 110 cm to 140 cm above the reference plane. This height corresponds approximately to the height of the shoulders of the horse. In other words, the height corresponds to about 60% to 90% of the height at the withers of a horse. The height at the withers of a horse is assumed to be 140 cm to 180 cm.

The stand has at least one top bar 39 located considerably above the horse, in particular at a height of more than 200 cm. In the exemplary embodiment according to FIG. 1, each of the side parts 20, 22 has an upper top bar 39, which has an excess length 28. The top bar 39 is supported by side bars 30, 31 which also each delimit the side part 20, 22 and, furthermore, form feet 32 with which the stand rests on the reference plane. The front side bars 30 and the rear side bars 31 are each connected by at least one lower bar 35. In the shown exemplary embodiments, the latter is located at a height of 40 cm to 100 cm above the reference plane. It extends in the x-direction.

Between both rear side bars 31 and between both front side bars 30 there is provided a door 24, 26, in particular a front door 24 and a rear door 26. These doors 24, 26 can be of identical construction. However, it is preferred that the rear door 26 ends in the z-direction at a height that is at least 10 cm, preferably 20 cm higher than the upper side of the front door 24. At the bottom, the doors preferably have a distance of 40 cm to 100 cm from the reference plane. Preferably, this distance, which is determined in the z-direction, is the same for both doors 24, 26. Preferably, the lower distances are the same for both side parts 20, 22 and both doors 24, 26.

The horse enters the stand through the front door 24 and leaves the stand through the rear door 26. As the exemplary embodiment according to FIG. 1 shows, a horse is substantially accommodated inside the stand; the head of the horse protrudes from the stand in the x-direction. It is located in front of the rear door 26. The horse is not cramped in the stand; its forward view is free. However, the stand offers the horse little lateral freedom of movement; the freedom of movement is between 10 cm and 40 cm on each side, thus in the y-direction. The stand also offers little free space to the horse forwards and backwards; the free space is between 10 cm and 40 cm at both the front and rear.

According to the first exemplary embodiment, the side parts 20, 22 and also the doors 24, 26 are filled, e.g. with a metallic grid, preferably a galvanised metallic grid. Such may be present, but does not need to be present. This also applies to the second exemplary embodiment; here, the vertical grid bars can be arranged in any other way or be omitted entirely. A net may also be provided at this position.

In the second exemplary embodiment according to FIGS. 2 and 3, both doors 24, 26 are each realised by means of a frame 36 and by a door leaf 38 movable within this frame. In contrast to the first exemplary embodiment, there is provided for each door 24, 26 a frame with side bars 30, 31, which here also form the feet 32. The frames of both doors 24, 26 are substantially, preferably entirely, identical in construction. The door leaves 38, as in the first exemplary embodiment, preferably differ due to different heights; they may however also be of equal height. The side parts 20, 22 can be delimited by end bars that form a frame together with the crossbar 34 and the lower bar 35. In the first exemplary embodiment, the side bars 30, 31 therein also take on the function of the end bars.

On each frame 36, in particular on one of its side bars 30 or 31, there are provided means for the releasably connecting the side parts 20, 22. The connection can be realised by means of a screw connection, but it may also be done by means of hooking or plugging, or by means of grips and clutches.

Preferably, at least one side part 20, 22 is configured as an outwardly pivotable door. Therefore, it is hinged to the one frame 36 about a pivot axis extending in the z-direction. At the other, free end, the side part is then connectable to the frame 36 there; for example, the side part 20, 22 can be hooked in, attached or otherwise fixed there. Alternatively, it is also possible to provide at least one side part 20, 22 with hooks to which hook openings on the side bars 30 or 31 are assigned. Thereby, the side part can be pulled upwards out of the stand.

Each of the frames 36 is made out of a round pipe, which is bent into a U-shape, and out of a flat connecting member 41, which are preferably manufactured from a galvanised metal. The connecting member 41 is located at the bottom, in the range of the reference plane. It connects the two free legs of the U with each other. The side parts are preferably also delimited by round pipes.

According to FIGS. 2 and 3, both frames 36 are connected by an upper top bar 39. It extends parallel to the x-direction and centrally above the side parts 20, 22. It is releasably connected to the frames 36; it determines the distance between the two frames 36 such that the unit of two frames 36 and the top bar 39 stands upright even without side parts or with only one side part.

On the reference plane lies a tub 40. It is preferably made from a plastic, such as polyester. It has a flat bottom and a peripheral wall with a height of about 10 cm to 30 cm. The tub 40 is located within a rectangle, whose corners are defined by the feet 32. It is advantageous to provide retaining means for the tub 40 which prevent displacement. Therefore, a retaining part 42 advantageously protrudes from the connecting members 41 of the frames 36 towards the tub 40. As a result, the tub is fixed at least in the x-direction, preferably also in the y-direction.

A mattress 44 is located in the tub 40, which covers the bottom of the tub 40. It is preferably made of a compact plastic foam, such as for example used for safety tiles for children's playgrounds. Alternatively, it is made of rubber and has large meshes. The mattress 44 is preferably non-slippery. It is approximately 2 cm to 8 cm thick, and preferably about 3 cm thick.

A water sprayer 46 is attached to the single top bar 39 of the second exemplary embodiment or between both upper top bars 39 of the first exemplary embodiment. Preferably, it is mounted such that from the front side of the stand to the water sprayer the distance is about 40 cm to 60 cm and from the water sprayer to the back side the distance is about 140 cm to 160 cm. It has a downwards, in negative z-direction, directed main spraying direction and sprays within a range, which is delimited by a pyramid, for example delimited by a cone. In this way spilling of water can be prevented as much as possible. Preferably, the water sprayer is provided with an adapted hood to delimit the spraying of the water spraying within the pyramid or cone. The discharge angle is dimensioned such that a large part, in particular more than 80%, and in particular more than 90%, of the sprayed water remains within the side parts 20, 22 and the doors 24, 26. The water sprayer 46 is mounted at a height of at least 150 cm above the reference plane. Preferably, its height is between 220 cm and 250 cm. An upper limit of 300 cm can be specified. The water sprayer 46 is preferably mounted centrally between the side parts 20, 22. Preferably, it is also mounted centrally between the doors 24, 26. It is however advantageous to mount the water sprayer moveable in the x-direction, e. g. on the upper top bar 39 according to the second exemplary embodiment, such that its position can preferably be changed in the x-direction in a middle third of the length of the top bar 39.

Preferred water sprayers 46 are sprinklers, which are also used for fire protection systems, for example in submarines. Preferably, the water sprayer 46 has a disc, optionally a rotating disc, provided with openings and/or slits through which the water passes, is shredded and scattered. The water sprayer is preferably provided with a hood. The hood preferably has the shape of a pyramid with a rectangular base, i.e. a rectangular right pyramid, of which the short sides are preferably arranged parallel to the front side of the stand, thus with the front door, and with the back side of the stand, thus with the rear door. The water sprayers are preferably made of inox, i.e. stainless steel.

At least one fan 48 is provided, and preferably two fans 48 are provided, near and above the front door 24. Therefore, a support arm 50 is releasably attached to a side bar 30, which, on the one hand, can be fixed in the height, i.e. in the z-direction, but, on the other hand, can also be swivelled around the side bar 30, see arrows. It has a seat 47 for the fan 48. Fans with a large surface area, for example at least 20 cm×20 cm, preferably at least 40 cm×40 cm base area of the outlet range, or with a corresponding diameter, are used as fans 48. In other words, the rotating rotor blades of the fan 48 have at least a radial dimension of 15 cm, preferably at least 20 cm. Because of the relatively large fans, it is possible to generate an air flow with a large cross section, but at very low wind speed. This air flow is directed substantially in the x-direction; it is directed such that the central beams of the air flow preferably cross each other, in particular a bit above the back of the horse. This means that the central beam of a fan 48 is directed such that it hits a point above the centre of the tub 40 at about the height at the withers. Preferably, the fan 48 is directed such that its central beam is directed at an angle to the z-direction of 60° to 80°, preferably 70° downwards.

The air flow preferably has a speed of less than 1 m/s, preferably less than 0.5 m/s and in particular less than 0.2 m/s. Less than 0.1 m/s is also possible. The volume of the transported air generally is 2 m³/s to 10 m³/s, in particular 5 m³/s to 7 m³/s.

Finally, the cooling device has a control unit 52. It is releasably connected to the stand, for example on a side bar, preferably on a side bar 30, 31 of the rear door 26. Water spraying can be switched on and off via the control unit 52, and the time period for water spraying can also be set. The operation of the fans can also be switched on and off and their duration set. The control unit comprises electronic devices to switch on and off the water and air flow.

For a carousel of a plurality of stands, a central control unit governs all stands. The central control unit is arranged on one of the stands, and it is operatively connected to the water input and electric wiring for all stands. From the central control unit, water and electricity is then directed to the other stands, respectively for spraying and for fan operation. All activities of sprayers and fans are configured into the central control unit, where the operating instructions, for turning on or off the water sprayers and/or fans, are entered into the software of e.g. a laptop.

Given the fact that many ‘eventing’ horses (endurance; cross-country) suffer from (subclinical) heart failures, the cooling device can be equipped with an ElectroCardioGram (ECG) device to monitor the heart rate and heart function during the cooling down procedure. The monitoring data can be transferred to a laptop using a Bluetooth connection through patches attached on so-called ECG spots on the skin of the horse. This device is also useful for intensive training of the sport horses, for example to determine its fitness for competition. The ECG device results interpretation assists in reducing health and welfare risks.

1. A cooling device for horses, in particular heat stressed horses, with a stand, which comprises a left and a right side part (22), a front door (24) and a rear door (26), with a water sprayer (46), which is arranged centrally between both side parts (20, 22) and both doors (24, 26) at a height of at least 150 cm, and which has a downwards directed water outlet, and with at least one fan (48) which is arranged adjustable in height and angular orientation above the front door (24) on the stand and directs an air flow with a slow speed to the central region of the stand, where in use the back of the horse is located.

2. The cooling device according to claim 1, wherein the cooling device comprises two fans (48) which are arranged adjustable in height and angular orientation above the front door (24) on the stand, wherein the two fans (48) are positioned at an offset from each other.

3. The cooling device according to claim 2, wherein the two fans (48) are aligned such that their air flows cross each other.

4. The cooling device according to claim 2 or 3, wherein the two fans (48) are aligned such that their air flows cross each other in the central region of the stand, where in use the back of the horse is located.

5. The cooling device according to any one of the claims 1-4, wherein the at least one fan (48) is configured for generating an airflow with a speed of less than 1 m/s, preferably less than 0.5 m/s, and more preferably less than 0.2 m/s.

6. The cooling device according to any one of the claims 1-5, wherein the at least one fan (48) is configured for generating an airflow transporting a volume of air in the range of 2 m³/s to 10 m³/s, and preferably in the range of 5 m³/s to 7 m³/s.

7. The cooling device according to any one of the claims 1-6, wherein the at least one fan (48) has a surface area of at least 20 cm×20 cm, and preferably of at least 40 cm×40 cm.

8. The cooling device according to any one of the claims 1-7, wherein rotor blades of the at least one fan (48) have a radial dimension of at least 15 cm, and preferably at least 20 cm.

9. The cooling device according to any one of the claims 1-8, wherein the water sprayer (46) is configured for spraying downwards in an angular range.

10. The cooling device according to claim 9, wherein the angle of the angular range is chosen such that substantially all water hits the back, and preferably the sides, of the horse, preferably from neck to tail, in use.

11. The cooling device according to claim 9 or 10, wherein the angle of the angular range relative to the downwards direction is at most 30°, and preferably at most 20°.

12. The cooling device according to any one of the claims 1-11, wherein the water sprayer (46) is configured for finely nebulising the water.

13. The cooling device according to claim 12, wherein the water droplets of the finely nebulised water have a diameter of at most 1 mm, preferably of at most 0.5 mm.

14. The cooling device according to any one of the claims 1-11, wherein the water sprayer (46) is configured for spraying water droplets imitating natural rainfall.

15. The cooling device according to claim 14, wherein the water droplets have a diameter of at least 0.5 mm, preferably at least 1 mm, more preferably at least 2 mm, and wherein the water droplets have a diameter of at most 8 mm, preferably at most 5 mm, and more preferably at most 4 mm.

16. The cooling device according to any one of the claims 1-15, wherein the water sprayer (46) is provided with a hood for delimiting the spraying within a predetermined range around the downwards direction.

17. The cooling device according to claim 16, wherein the hood has the shape of a cone or a pyramid.

18. The cooling device according to claim 16 or 17, wherein the hood has the shape of a rectangular right pyramid, of which the short sides of the rectangular base are arranged substantially parallel to the front door (24) and the rear door (26).

19. The cooling device according to any one the claims 1-18, wherein the cooling device further comprises a monitoring system configured for monitoring at least one clinical parameter of the horse representative for heat stress.

20. The cooling device according to claim 19, wherein the monitoring system comprises an electrocardiogram device configured for monitoring the heart rate and/or heart function of the horse.

21. The cooling device according to any one of the claims 1-20, wherein the side parts (20, 22) and the doors (24, 26) are releasably, preferably pluggable and/or screwable, connected to each other.

22. The cooling device according to any one of the claims 1-21, wherein the side parts (20, 22) and/or the doors (24, 26) are flat parts with length and width dimensions, which are each at least ten times as large as the thickness.

23. The cooling device according to any one of the claims 1-22, wherein both side parts (20, 22) and/or both doors (24, 26) are substantially of identical construction.

24. The cooling device according to any one of the claims 1-23, wherein the side parts (20, 22) have a length of 120 cm to 250 cm, in particular 160 to 210 cm.

25. The cooling device according to any one of the claims 1-24, wherein the doors (24, 26) have a width of 60 cm to 130 cm, preferably 80 cm to 115 cm.

26. The cooling device according to any one of the claims 1-25, wherein the doors (24, 26) and/or the side parts (20, 22) have a crossbar (34) located at a height of 110 cm to 140 cm above the reference plane, in particular the ground.

27. The cooling device according to any one of the claims 1-26, wherein the cooling device further comprises a tub (40), which is arranged in the stand between the side part (20, 22) and the doors (24, 26) and which substantially fills the horizontal surface spanned by the stand.

28. The cooling device according to any one of the claims 1-27, wherein the stand comprises at least one upper top bar (39), which extends parallel to the reference plane and is arranged at a height of 200 cm to 270 cm, in particular 220 cm to 240 cm.

29. The cooling device according to any one of the claims 1-28, wherein the cooling device comprises a plurality of the stands, each provided with the water sprayer (46) and the at least one fan (48).

30. A method for cooling down heated horses, in particular heat stressed horses, using a cooling device according to any one of the claims 1-29, characterised by the following method steps:
a) a horse is first led through the front door (24) into the stand; the front door (24) is then closed again; the rear door (26) remains closed,
b) in a first step, water is directed via the water sprayer (46) onto the back of the horse, preferably from the neck to the tail of the horse, this is done for at least a few seconds or at least a few minutes,
c) subsequently, the then wet hair coat of the horse is freed from the water, for example by wiping off the water or by rubbing it dry,
d) in a second step, a weak air flow is then directed by the at least one fan (48) onto the back of the horse from behind, this is done for a few minutes,
e) finally, the rear door (26) is opened, and the horse is led out of the stand.

31. The method according to claim 30, at least in combination with claim 12 or 13, wherein during step b) finely nebulised water is directed via the water sprayer (46) onto the back of the horse for at least a few minutes.

32. The method according to claim 31, wherein during step b) the finely nebulised water is directed via the water sprayer (46) onto the back of the horse for at least 1 minute, preferably for at least 2 minutes, more preferably for at least 3 minutes, and for at most 7 minutes, preferably for at most 6 minutes, more preferably at most 5 minutes.

33. The method according to claim 30, at least in combination with claim 14 or 15, wherein during step b) water droplets imitating natural rainfall are directed via the water sprayer (46) onto the back of the horse for at least a few seconds.

34. The method according to claim 33, wherein during step b) the water droplets imitating natural rainfall are directed via the water sprayer (46) onto the back of the horse for at least 10 seconds, preferably for at least 20 seconds, more preferably for at least 30 seconds, and for at most 80 seconds, preferably for at most 70 seconds, more preferably for at most 60 seconds.

35. The method according to any one of the claims 30-34, wherein steps b), c) and d) are repeated for further cooling the horse.

36. The method according to any one of the claims 30-35, at least in combination with claim 19, wherein at least at the end of step d), preferably during steps b), c) and d), at least one clinical parameter of the horse representative for heat stress is monitored by means of the monitoring system, and wherein the steps b), c) and d) are repeated if the monitored at least one clinical parameter indicates that the horse still suffers from heat stress.
